(19) United States
(12) Patent Application Publication
(10) Pub. No.: US 2007/0007089 A1
(43) Pub. Date: Jan. 11, 2007

(54) Wheelbarrow with braking system

(75) Inventors: Irwin I. Silberman, Monsey, NY (US); William Kurt Feick, New Canaan, CT (US)

Correspondence Address: ST. ONGE STEWARD JOHNSTON & REENS, LLC, 986 BEDFORD STREET, STAMFORD, CT, 06905-5619, US

(73) Assignee: The Aim Group, LLC, Port Chester, NY (US)

(21) Appl. No.: 11/176,923

(22) Filed: Jul. 7, 2005

(51) Int. Cl. F16D 65/14

(52) U.S. Cl. 188/2 D; 188/17; 188/77 W

(57) ABSTRACT

A braking system for a wheelbarrow comprises a brake assembly which includes a band-type braking member and a link member connected to the braking member, wherein the braking member encircles more than about one half of the outer circumference of the wheel flange of the wheel. The wheelbarrow braking system further comprises a cable having a first end and a second end, the first end connected to the link member, and a brake applicator operatively connected to the second end of the cable, the brake applicator configured to apply a tensioning stress to the cable and to enable movement of the link member such that the movement of the link member can cause a frictional contact of the band-type braking member against the outer circumference of the wheel flange of the wheel for applying a braking action to the wheel.

### FIELD OF THE INVENTION

The present invention relates generally to a wheelbarrow, and more particularly to a wheelbarrow having a braking system with a band-type braking member for applying a braking force to the wheel of the wheelbarrow.

### BACKGROUND OF THE INVENTION

Wheelbarrows and low speed weight-carrying vehicles of similar kinds are useful to carry relatively heavy loads manually to a desired location. Wheelbarrows generally include a tray or bin, at least one wheel, and a frame having a pair of legs and a pair of handles attached thereto. A wheelbarrow is moved to a desired location by the operator while lifting its handles to raise the legs off the ground and balancing the wheelbarrow on its wheel. It is known to provide a wheelbarrow with braking system for controlling the speed of the vehicle and also for stopping the wheel or holding it in a stopped position for safety purposes.

Various designs of wheelbarrow braking systems are known in the art. For example, U.S. Pat. No. 2,716,031 issued to Roessler discloses a wheelbarrow brake system having a brake crank or lever, a connection rod coupled with the brake lever, and a brake shoe connected to the connection rod and to a linkage mechanism for applying a braking force to a wheel rim or web of the wheel.

U.S. Pat. No. 4,962,833 issued to McCurdy discloses a wheelbarrow brake system having a cable extending from the brake to a belt worn by the operator, and a shoe-type brake connected to the cable for applying a braking force to a wheel rim or web of the wheel.

U.S. Pat. Nos. 5,690,191 and 6,443,267 issued to Burbank disclose a wheelbarrow brake system having a hand brake means, a cable connected to the hand brake means, and a brake disc engaging with a pair of brake pads for applying a braking force to the wheel.

### SUMMARY OF THE INVENTION

The present invention is directed to a novel braking system for a wheelbarrow, and a wheelbarrow having the braking system. The braking system of the invention includes a hand brake actuator, a cable operatively connected to the brake actuator, and a brake assembly coupled with the cable for applying a braking force to the wheel. The brake assembly includes, among other members, a band-type braking member which is coupled with a link member for applying the braking force directly on the brake hub, and/or to a flange of the wheel, upon tensioning of the cable.

In accordance with one aspect of the invention, a braking system for a wheelbarrow comprises a brake assembly which includes a band-type braking member and a link member connected to the braking member, wherein the braking member encircles more than about one half of the outer circumference of the brake hub flange. The wheelbarrow braking system further comprises a cable having a first end and a second end, the first end connected to the link member, and a hand brake actuator operatively connected to the second end of the cable, the hand brake actuator configured to apply a tensioning stress to the cable and to enable movement of the link member such that the movement of the link member can cause a frictional contact of the band-type braking member against the outer circumference of the wheel flange of the wheel for applying a braking action to the wheel.

The brake assembly of the wheelbarrow braking system preferably includes a cylindrical brake hub sleeve with a circumferential flange mounted on the wheel, and the band-type braking member is configured to apply the frictional contact against the circumferential flange of the brake hub for applying the braking action. The braking member of the brake assembly preferably includes a metal band, and a brake lining disposed at an inner circumference of the metal band for the frictional contact against the outer circumference of the hub.

In accordance with another aspect of the invention, a wheelbarrow comprises a frame, a wheel rotatably disposed on an axle mounted to the frame, and a braking system for braking operations to the wheel, the wheel having a brake hub and/or flange laterally extending from the wheel, wherein the braking system of the wheelbarrow includes: (a) a brake assembly including a band-type braking member, the braking member encircling more than about one half of the outer circumference of the wheel flange or rotatable member of the wheel, the brake assembly further including a link member connected to the braking member; (b) a cable having a first end and a second end, the first end connected to the link member; and, (c) a hand brake actuator operatively connected to the second end of the cable, the hand brake actuator configured to apply a tensioning stress to the cable and to enable movement of the link member such that the movement of the link member can cause a frictional contact of the band-type braking member against the outer circumference of the brake hub and/or flange of the wheel for applying a braking action to the wheel.

Other aspects, objects and features of the invention in addition to those mentioned above will be pointed out or will be understood from the following detailed description provided in conjunction with the accompanying drawings.

### BRIEF DESCRIPTION OF THE DRAWINGS

FIG. 1 is a perspective view of a wheelbarrow including a wheelbarrow brake system constructed in accordance with one embodiment of the invention.

FIG. 2 is a perspective view illustrating one preferred embodiment of the brake applicator of the braking system constructed according to the invention.

FIG. 3 is a perspective view illustrating an assembled state of the brake assembly of the braking system with a wheel assembly, constructed according to one embodiment of the invention.

FIG. 4 is a perspective view illustrating the cylindrical hub of the brake assembly of FIG. 3.

FIG. 5 is a side elevation view illustrating the brake assembly of FIG. 3 in a non-braking position.

FIG. 6 is a side elevation view illustrating the brake assembly of FIG. 3 in a braking position.

FIG. 7 is a perspective view illustrating one embodiment of the cable connection structure for connecting the cable to the link member according to the invention.

FIG. 8 is a perspective view illustrating one embodiment of the cable guide structure for guiding the cable to the brake assembly according to the invention.

### DETAILED DESCRIPTION OF THE DRAWINGS

Preferred embodiments of the invention are described herein-after with reference to the accompanied drawings. Like elements are identified by the same or similar reference numbers throughout the drawings. In this disclosure, the terms “proximal” and “distal” are generally intended to describe a direction or a portion of the wheelbarrow or its components at issue based on the observation by the operator who stands behind the wheelbarrow for driving the wheelbarrow to a desired direction or who observes the wheelbarrow from the side.

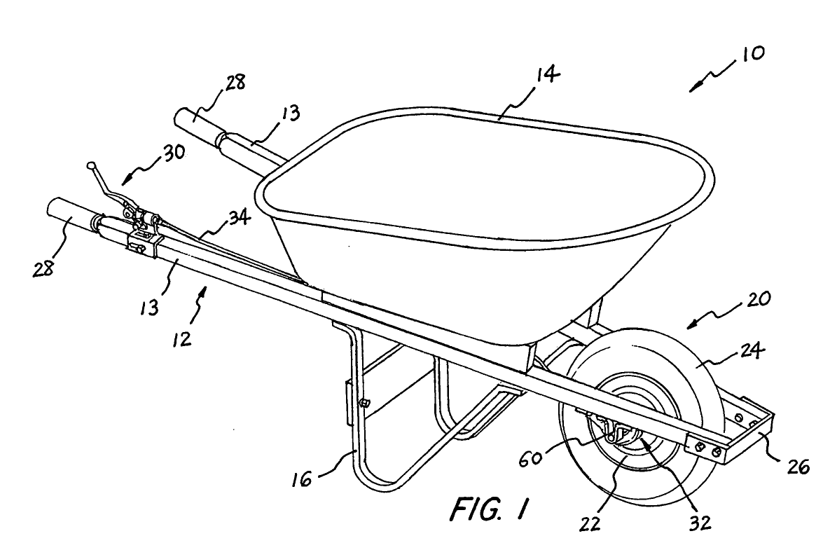

FIG. 1 illustrates one embodiment of a wheelbarrow with a braking system constructed in accordance with the concepts and principles of the present invention. Wheelbarrow 10 includes frame 12 with a pair of arm members 13, bin or tub 14 and a pair of stands 16 respectively mounted to the frame 12. Wheelbarrow 10 further includes at least one wheel assembly 20 with wheel rim 22 and tire 24 rotatably connected to the frame 12. Wheelbarrow 10 further includes wheelbarrow bumper 26 attached at the front (i.e., distal) end of the frame 12, and a pair of handle grips 28 at the proximal end of each of the arm members 13. Other functional and additional components may be further provided for various functions of the wheelbarrow.

The wheelbarrow 10 includes, for braking operations of the wheel assembly, a braking system which is composed basically of a hand brake actuator 30 and brake assembly 32 (details shown in FIGS. 3, 5, and 6). The hand brake actuator 30 is pivotally and operatively connected to the brake assembly 32 by cable 34 for the braking operations of the wheel.

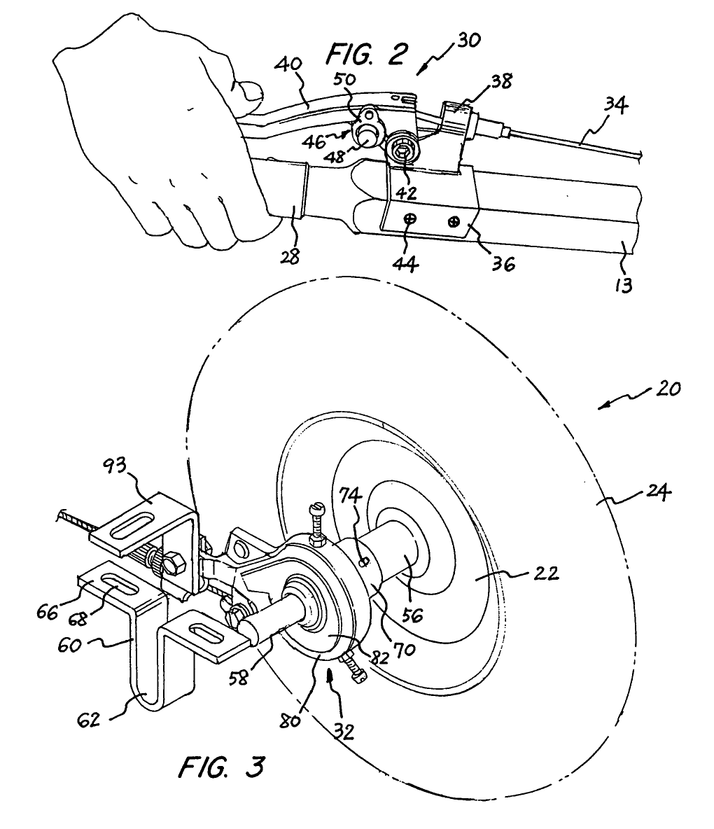

Referring to FIG. 2, the hand brake actuator 30 of the braking system of the invention includes mounting bracket 36, pivot base 38 extending upwards from the mounting bracket 36, and pivot lever 40 pivotally connected at a proximal portion of the pivot base 38 with pivot shaft 42. The pivot lever 40 includes a yoke-shaped distal end in which a proximal end of the pivot base 38 is received for the pivotal connection of the two with the pivot shaft 42. The mounting bracket 36 is preferably formed with a thin metal plate enclosing the arm member 13 and affixed thereto with bolts 44. The hand brake actuator 30 is attached at a proximal end of the arm members 13 of the wheelbarrow 10 with the mounting bracket 36 affixed at a suitable location of the arm members 13. The pivot lever 40 extends parallel to the handle grip 28 for easy gripping of the pivot lever 40 with a hand of the operator as shown.

It is noted that the hand brake actuator of the invention is not limited to the particular embodiment shown in FIG. 2, and can incorporate other known structures for the wheelbarrow brakes or the like which utilize a operating cable connected thereto for actuating the braking operation of the wheel.

The cable 34 extends through an opening formed at an upper portion of the pivot base 38 generally in parallel relation with the arm member 13, and a proximal end of the cable 34 is attached to a distal and upper end portion of the pivot lever 40. Thus, when the operator grips the pivot lever 40 against the handle grip 28 as shown in FIG. 2, the cable 34 becomes tightened and causes a braking action to the brake assembly 32 to stop or hold rotation of the wheel assembly 20. The operation of the brake assembly 32 will be described in details later with reference to FIGS. 5 and 6.

The hand brake actuator 30 preferably includes lock member 46 for locking its braking position for security or safety purposes. As shown, the lock member 46 can be in form of spring-actuated lock pin 48 housed in base 50 which is affixed at a suitable distal portion of the pivot lever 40. The lock pin 48 includes a locking extension (not shown) at its terminal end for releasable engaging with an opening (not shown) in the proximal end of pivot base 38 for locking of the braking position. Thus, after the operator squeezes the brake actuator 30 as shown in FIG. 2, the operator can push the locking pin 48 into the opening of the pivot base 38 to lock the braking position. The operator can release the lock by pushing down on the locked brake actuator 30 to release the pin 48 which pops back to its initial position.

The hand brake actuator 30 preferably includes a biasing means to restore its initial position when the operator presses on the brake applicator 30 (i.e., the pivot lever 40).

Referring now to FIG. 3, the brake assembly 32 constructed according to one preferred embodiment of the invention is shown in an assembled state with the wheel assembly 20. As described above, the wheel assembly 20 includes the tire 24 and the wheel rim 22 which are rotatably mounted on an axle or stationary shaft fixed to the arm members 13 of the wheelbarrow 10 as described herein below. The wheel rim 22 has wheel flange 56 extending laterally from the center of the wheel rim 22 and having a cylindrical outer circumference. The wheel flange 56 has a longitudinal center hole which houses a bearing or bushing hub for rotatably receiving axle 58 therein and thus enabling rotation of the wheel 20 (with the wheel rim 22 and the flange 56) on the axle 58. Both of the terminal ends of the axle 58 are held by suitable holders, such as U-like axle brackets 60 having circular groove 62 for receiving a respective end of the axle 58. The U-like axle bracket 60 includes upper extensions 66 which extend horizontally from the upper portions of the axle bracket 60 and 65 have mounting holes 68 for mounting the axle bracket 60 (and thus the assembled wheel 20) to the frame 12 with bolts, as shown in FIG. 1.

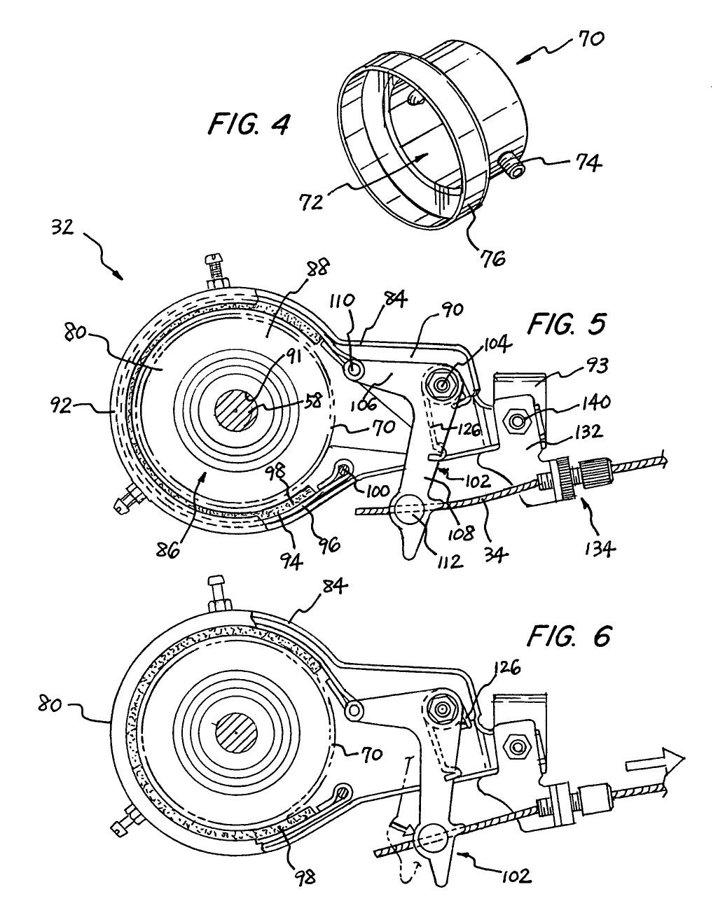

According to the embodiment shown in FIG. 3, the brake assembly 32 includes brake hub 70 in the form of a cylindrical sleeve mounted at a terminal end of the wheel hub 56, and the brake assembly 32 is positioned on the brake hub 70. As shown in FIG. 4, the brake hub 70 has axial hole 72 for receiving a terminal end of the wheel hub 56 therein, and is fixedly mounted to the terminal end of the wheel hub 56, for example, by bolts 74. The brake hub 70 preferably includes a brake flange 76, a circular outer circumference against which a frictional force is to be applied for braking operations of the wheel, as will be described herein in below in details.

According to an alternative embodiment, the brake assembly 32 may dispense with the cylindrical sleeve 70, and the brake assembly 32 can directly be positioned on the wheel hub 56 (or any other rotating member of the wheel extending from the center of the wheel and rotating with the wheel if the wheel is constructed with a different structure). Thus, the brake assembly 32 can apply a frictional force particularly onto the cylindrical outer surface of the wheel hub 56 or any rotating shaft of the wheel for braking operations of the wheel.

Referring to FIGS. 3 and 5-6, further details of the brake assembly and operations of the brake assembly are described herein. Brake assembly 32 includes housing 80 for at least partially enclosing components of the brake assembly therein. According to one preferred embodiment, the housing 80 is formed of a thin plate and includes a partially open construction with a substantially closed front face member 82, side wall portions 84 extending in a right angle from the front face 82, and an opened rear surface 86. The front face 82 covers the front side of the brake assembly 32 with circular portion 88 and laterally extending portion 90, and includes circular opening 91 at the center of the circular portion 88 for receiving the axle 58 there-through. The side wall portions 84 cover a majority portion of the side of brake assembly 32, and the front face 82 and the side walls 84 protect the components of the brake assembly from a physical access or dust. The rear side of the brake assembly 32 includes circular extension 92 extending towards the central opening 91 from the circular area of the side wall portions for partially covering the rear side of the brake assembly 32. The brake assembly 32 further includes L-like bracket 93 with a vertical end portion fixed at the front face of the housing 80 and a horizontal end portion for mounting the brake assembly 32 to the frame 12 or handle 13.

Braking member 94 is positioned into the opened rear surface 86 of the housing 80 for selectively providing a frictional braking stress against the outer surface of the cylindrical brake hub 70 (shown with broken lines in FIGS. 5 and 6). The braking member 94 is formed into a circular shape encircling a majority portion of the outer surface of the brake flange 76. The braking member 94 encircles the brake hub 70 (or the wheel hub 56) preferably more than about one half of, more preferably more than two thirds of, the periphery of the brake hub 70. The braking member 94 is preferably composed of metal band 96 formed in the corresponding circular shape, and brake lining 98 of suitable frictional material attached at the inner circular surface of the metal band 96. First terminal end of the metal band 96 is fixed at the housing 80 with a pivotal shaft 100.

The brake assembly 32 includes a link or cam member 102 for transmitting a tension of the cable 34 for applying a braking operation to the wheel 20 when the brake applicator 30 is in a braking position as described above with FIG. 1. The link member 102 is preferably formed into an L-like shape and rotatable about pivot shaft 104 fixed at the housing 80. However, the particular construction, type and shape of the link or cam member 102 can be varied, and various known mechanisms for such a link and cam can be adopted as long as they can apply a suitable tensioning stress to the braking member 94 in association with the tensioning of the cable 34.

The link member 102 of L-like shape has first arm 106 and second arm 108 extending laterally from the pivot area of the link member as shown in FIG. 5. A floating pivot pin 110 is fixed on the terminal free end of the first arm 106 and second terminal end of the metal band 96. The floating pivot pin 110 can move (i.e., float) in a path defined by the link member 102 upon rotation of the link member 102, and can also provide a relative rotation between the link member 102 and the second terminal end of the metal band 96. A suitable cable connection means, such as cable connection pin 112, is provided at the terminal free portion of the second arm 108 of the link member 102 for affixing the free end of the cable 34. The length from the connection point 112 of the cable to the pivot shaft 104 is preferably larger than the length between the pivot shaft 104 and the first end of the link member where the floating pivot pin 110 is affixed. This arrangement magnifies for a firm braking operation the tensile force applicable to the floating pivot 110 of the braking member 94 from the tensioning force applied by the cable 34 on the second arm 108.

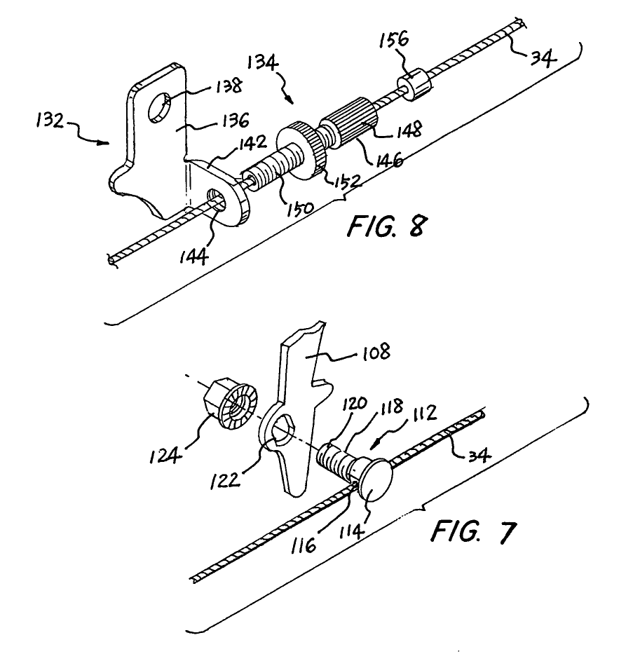

Referring to FIGS. 5 and 7, the cable connection pin 112 includes head portion 114 with a transverse hole 116 formed across through the head portion 114 for receiving the cable 34 there-through, and body portion 118 with screws 120 are inserted to a through hole 122 in the terminal end of the second arm 108 of the link member 102 and engaged with nut 124 for quick and secure connection of the cable 34 to the link member 102. The connection of the cable to the link member 102 can be realized by other known connection structures different than that illustrated herein above.

The brake assembly 32 preferably includes a bias means for biasing the link member 102 (and thus the braking member 94) to be in a non-braking position (FIG. 5) when the brake applicator 30 is not manipulated for applying the braking operation. As shown in FIGS. 5 and 6, the bias means can be in form of coil spring 126 positioned on the pivot shaft 104 of the link member 102, which has one free end engaged with the housing 80 and the other free end locked with the second arm 108 of the link member 102 for pushing the link member 102 towards the non-braking position as shown in FIG. 5. However, when the brake actuator 30 is applied for the braking operation, the tension applied on the cable 34 overcomes the spring force of the coil spring 126 and pulls the link member 102 counterclockwise. This rotation of the link member 102 results in the braking operation as shown in FIG. 6 where the inner friction surface of the braking member 94 applies a braking force against the outer circumference of the brake hub 70 and/or brake flange 76 (alternatively against the wheel flange 56 when the hub 70 is not used).

The brake assembly 32 preferably includes a cable guide means disposed adjacent to the link member 102 for guiding the cable 34 to the brake assembly 32. As shown in FIGS. 5 and 8, the cable guide means can be in form of a generally L-like bracket 132 and a guide member 134 coupled with each other for guiding the cable 34. The bracket 132 includes mounting portion 136 with bolt hole 138 for mounting the bracket 132 to the housing 80 with bolt 140, and extending portion 142 extending in a right angle from the mounting portion 136 and having a screw hole 144 therein. The guide member 134 includes bolt member 146 with knob portion 148 and bolt portion 150 for engaging with the screw hole 144. The bolt member 146 has a longitudinal bore there-through for receiving and guiding the cable 34 therein. The guide member 134 may include nut 152 engaged on the bolt portion 150 and for securely connecting the bolt member 146 to the bracket 132.

The brake assembly 32 may further include a cable displacement limiting means for limiting the return stroke of the cable 34 from the braking position to the non-braking position. As shown in FIG. 8, the cable displacement limiting means can be in form of stopper 156 fixed on the cable 34 for limiting the return stroke of the cable 34 upon stopping by the knob portion 148 of the bolt member 146 when the brake actuator 30 is released.

While the present invention has been particularly shown and described with reference to preferred embodiments thereof, it will be understood by those ordinary skill in the art that various changes in form and details may be made therein without departing from the spirit and scope of the present invention as defined by the following claims.

What is claimed is:

1. A braking system for a wheelbarrow, the wheelbarrow including a frame, an axle, and a wheel rotatably attached to the axle, said wheel including a wheel hub and a tire, the braking system comprising:
a brake hub mounted to said wheel hub, said brake hub comprising an inner sleeve and an outer flange,
a brake assembly including a band-type braking member, the braking member encircling more than about one half of the outer flange of the brake hub, the brake assembly further including a pivoting link member having one end connected to the braking member and another end connected to a first end of a cable; and
a hand brake actuator operatively connected to the second end of the cable, the hand brake actuator being configured to apply a tensioning stress to the cable and to enable movement of the link member such that the movement of the link member causes a frictional contact of the band-type braking member against the outer flange of the brake hub of the wheel for applying a braking action to the wheel.

2. The braking system of claim 1, wherein the braking member of the brake assembly includes a metal band, and a brake lining disposed at an inner circumference of the metal band for the frictional contact against the outer circumference of the hub.

3. The braking system of claim 2, wherein the brake assembly further includes a housing containing said metal band and brake lining.

4. The braking system of claim 2, wherein the metal band of the braking member has a first end pivotally fixed to the housing and a second end pivotally fixed to said one end of the link member.

5. The braking system of claim 4, wherein the link member of the brake assembly is rotatable about a pivot shaft fixed to the housing.

6. The braking system of claim 5, wherein the link member is generally L-shaped, and the length between said one end of the link member and the pivot shaft is less than the length between said another end of the link member and the pivot shaft.

7. The braking system of claim 6, wherein the brake assembly further includes a bias member for biasing the link member and the braking member to a non-braking position.

8. The braking system of claim 7, wherein the bias member of the brake assembly is a spring positioned about the pivot shaft.

9. The braking system of claim 3, wherein the housing of the brake assembly includes a circular opening for receiving the axle of the wheel of the wheelbarrow.

10. The braking system of claim 9, wherein the housing of the brake assembly includes a mounting bracket for attaching the brake assembly to the frame or a handle of the wheelbarrow.

11. The braking system of claim 10, wherein the brake assembly further includes a cable guide member with a hole for receiving the cable there-through.

12. The braking system of claim 11, wherein the brake assembly further includes a cable displacement limiting member associated with the cable guide member for limiting the return stroke of the cable from the braking position and to the non-braking position.

13. The braking system of claim 1, wherein the hand brake actuator includes a pivot base affixed at a proximal portion of the frame, and a pivot lever pivotally affixed to the pivot base.

14. The braking system of claim 13, wherein the hand brake actuator further includes a locking mechanism for locking the braking system in a braking position.

15. The braking system of claim 14, wherein the locking mechanism of the hand brake actuator includes a locking pin adapted to engage with a hole in the pivot base for the locking of the brake system.

16. The braking system of claim 14, wherein the locking mechanism of the hand brake actuator includes a catch attached to said pivot base for releasabley trapping said hand brake actuator.

17. The braking system of claim 13, wherein the hand brake actuator includes a biasing means for biasing the hand brake actuator to a non-braking position.

18. A wheelbarrow comprising: a frame; an axle; a wheel rotatably disposed on the axle; said wheel having a braking flange attached thereto; and a braking system for applying braking friction to the wheel;
said braking system having a band-type braking member, the braking member encircling more than about one half of the outer circumference of the braking flange, said braking member being actuated by a pivoting link attached to said braking member at one end thereof, and to a cable at another end thereof;
a hand brake actuator operatively connected to said cable, the hand brake actuator being configured to apply a tensioning stress to the cable and to enable movement of the link member such that the movement of the link member causes a frictional contact of the band-type braking member against the outer circumference of the braking flange for applying frictional braking to the wheel.
